(19) United States
(12) Patent Application Publication
(10) Pub. No.: US 2011/0219931 A1
(43) Pub. Date: Sep. 15, 2011

(54) ACTIVE SCRAPER AND APPARATUS FOR MANUFACTURING LIGHT GUIDE PLATE USING THE SAME

(75) Inventor: BONG GU HEO, DAEGU (KR)

(73) Assignee: IST KOREA CO., LTD., DAEGU (KR)

(21) Appl. No.: 13/042,614

(22) Filed: Mar. 8, 2011

(30) Foreign Application Priority Data
Mar. 15, 2010 (KR) 10-2010-0022979

(51) Int. Cl. B26D 3/06

(52) U.S. Cl. 83/875

(57) ABSTRACT

An active scraper which can form a scattering pattern on a light guide plate to a uniform depth even when the light guide plate has a curved surface, and an apparatus for manufacturing a light guide plate using the active scraper. The active scraper includes a drive-force generating part which generates drive force, and a transmitting part which transmits the drive force to teeth of a body part. The active scraper further includes the body part which converts the drive force into surface-unit drive force corresponding to the width of the body part, and a scraping part which is provided on the end of the body part. The scraping part converts the surface-unit drive force into line-unit drive force. The teeth are provided on the scraping part and form grooves of a scattering pattern in a light guide plate at a predetermined pitch.

### CROSS-REFERENCE TO RELATED APPLICATION AND CLAIM OF PRIORITY

This application claims the benefit of Korean Patent Application No. 10-2010-0022979, filed on Mar. 15, 2010, in the Korean Patent and Trademark Office, the disclosures of which are incorporated herein in their entirety by reference.

### BACKGROUND OF THE INVENTION

1. Field of the Invention

The present invention relates to scrapers for scraping the surfaces of edge-type light guide plates to form optical scattering patterns having uniform depths, and an apparatus for manufacturing a light guide plate using the active scraper.

2. Description of the Related Art

LCDs (liquid crystal displays) which are one kind of FPDs (flat panel displays) using TFT (thin film transistor) techniques are representative examples of devices for actively and visually displaying a variety of information.

The information includes not only visual information but also auditory information, olfactory information, tactile information, etc. Displaying information passively may use, for example, paper, as a medium. Such LCDs have liquid crystals which are in an intermediate state between solid and liquid. The LCDs visually display information in such a way as to three-dimensionally control the orientation of liquid crystals so that reflection and transmission of light are controlled.

Furthermore, the LCDs control liquid crystals constituting each pixel in a digital manner. Therefore, they can provide more definite and clear image information. Furthermore, an area over which information is displayed can be comparatively increased by a lot, and the image quality is very superior. Moreover, the LCDs have advantages of reduced weight, volume and power consumption and superior mobility and portability.

However, unlike CRT (cathode ray tube) displays which are self emissive, the LCDs are non-emissive, so that a separate light source is required.

Depending on the method of supplying light, there is a light reflection method in which a light source is located in the front side of a display to supply light thereto, a light transmission method in which a light source is located in the rear side of a display to supply light thereto, and a reflection-transmission combined method.

A light source device used in the light transmission method is called a back light unit (BLU), and a light source device used in the light reflection method is called a front light unit (FLU).

Particularly, BLUs are classified into a direct lighting BLU and an edge lighting BLU according to the method of positioning a light source.

Generally, a light source is a point light source. A line light source includes a plurality of point light sources which are arranged in a line. A surface light source includes a plurality of line light sources which are successively arranged in parallel.

The LCDs require such surface light sources. Particularly, in the case of LCDs using the light transmission methods, a surface light source requires a diffusion plate or light guide plate (hereinafter, referred to as a ‘light guide plate’) which evenly scatters light of a light source to provide uniform brightness to a comparatively wide display area.

In the direct lighting BLUs, a plurality of light sources is disposed behind a light guide plate, thus forming a surface light source. The light guide plate scatters light to give it a uniform brightness and then supplies the light to a liquid crystal layer. In the edge lighting BLUs, a plurality of light sources is arranged in a line on an edge of a light guide plate. The light guide plate uniformly scatters light emitted from the light sources, thus converting the light sources into a surface light source before the light enters the liquid crystal layer.

As such, the BLUs typically include a light source, a light guide plate and a reflective plate.

In the edge lighting BLUs, light sources are disposed on an edge of a light guide plate. Thus, a relatively thin structure can be embodied, so that the edge lighting BLUs are mainly used in small, light and thin display devices, for example, portable display devices. On the other hand, in the direct lighting BLUs, because light sources are located behind the light guide plate, the thickness of a display using a direct lighting BLU is increased, but light efficiency is superior, so that the image quality of the display can be enhanced. Therefore, the direct lighting BLUs are mainly used in displays, such as monitors for TVs, which require large screens.

Typically, such light guide plates include an optical scattering pattern which has a predetermined shape and refracts, specularly reflect, diffusely reflect and diffracts light emitted from the light sources to evenly scatter the light and thus form a surface light source.

A screen printing method using ink mixed with resin, bead and adhesive is one representative example of conventional methods of forming optical scattering patterns on light guide plates.

However, it is difficult to uniformly repetitively print scattering patterns depending on conditions of resin or particles of beads which are mixed with ink, or a difference of the amount of adhesive mixed with ink, or conditions of the surface of the light guide plate. Thus, the number of defective products is increased.

Furthermore, in the case of a complex scattering pattern, ink may easily blur or overlap, thus deforming the pattern. Therefore, it is very difficult to form a surface light source having uniform brightness. With the lapse of time, a portion of the printed optical scattering pattern may be separated therefrom, resulting in a shortened lifespan.

As another method of forming optical scattering patterns, a technique of directly forming an uneven surface on the surface of the light guide plate using chemical corrosion or laser or mechanical machining is gaining in popularity. In the case of a technique using chemical corrosion, it is however difficult to precisely control the depth of the uneven surface.

Therefore, the technique of forming the optical scattering patterns has been focused on a technique of mechanically forming an uneven surface on the surface of the light guide plate using a scraper.

However, the conventional mechanical forming technique requires that the surface of the light guide plate be very flat, because the optical scattering pattern cannot be formed in the light guide plate to a uniform depth if the light guide plate is not flat.

In addition, the scraper that is precisely manufactured is comparatively expensive but the lifetime thereof is relatively short. Thus, there is a problem in that the production cost of the light guide plate is increased.

Meanwhile, while the scraper forms the scattering pattern on the light guide plate, very small chips break off of the light guide plate. If such chips remain on the light guide plate even after the forming of the scattering pattern has been completed, these chips result in a white point phenomenon which makes the brightness of the surface light source non-uniform.

Furthermore, during the process of forming the scattering pattern on the light guide plate using the scraper, protrusions are formed on opposite sides of the scattering pattern. These protrusions may scratch a reflective sheet and act as impurities resulting in defective products.

Therefore, an improved technique is required, which can form the optical scattering pattern on the light guide plate to a uniform depth even when the light guide plate is not flat and can prevent undesirable protrusions from being formed around the scattering pattern.

Furthermore, an improved technique is required, which can prevent small chips from remaining on the light guide plate when grooves of the scattering pattern are formed in the light guide plate by scraping and can enhance the durability of the scraper.

### SUMMARY OF THE INVENTION

Accordingly, at least some embodiments of the present invention have been made keeping in mind the above problems occurring in the prior art, and an aspect of the present invention is to provide an active scraper which is configured such that even when a light guide plate has a curved surface or is twisted depending on surrounding conditions or the temperature variation of a work site, the scraper can move along the curved surface of the light guide plate and form an optical scattering pattern on the light guide plate to a uniform depth, and an apparatus for manufacturing a light guide plate using the active scraper.

Another aspect of the present invention is to provide an active scraper which can reliably remove protrusions formed on opposite sides of the scattering pattern without breaking off chips while the scattering pattern is being formed on the light guide plate by scraping, and an apparatus for manufacturing a light guide plate using the active scraper.

A further aspect of the present invention is to provide an active scraper which can prevent very small chips acting as impurities from being generated while the scattering pattern is formed on the light guide plate and can increase the lifetime of the scraper, and an apparatus for manufacturing a light guide plate using the active scraper.

In an aspect, an active scraper, including a unit scraper including: a drive-force generating part generating a predetermined intensity of drive force in a linear direction; a transmitting part to transmit the drive force generated from the drive-force generating part in the linear direction to a body part; the body part converting the drive force of the transmitting part into a surface-unit drive force corresponding to a standardized width of the body part; and a scraping part provided on a lower end of the body part, the scraping part converting the surface-unit drive force into a line-unit drive force, with the teeth provided on the scraping part within the standardized width at integer times, the teeth forming grooves of a scattering pattern in a light guide plate at a predetermined pitch.

The drive-force generating part may include: a drive unit generating the predetermined intensity of the drive force in the linear direction; a body having a first hole containing the drive unit therein, and a second hole communicating with the first hole, the second hole receiving the transmitting part therein; and a stopper closing a corresponding end of the first hole to prevent the drive unit from being removed from the first hole.

The drive unit may include one selected from among a spring, an air cylinder and an oil cylinder.

The drive unit may generate the predetermined intensity (kgf) of drive force in direct proportion to the number of teeth.

The teeth may scrape the light guide plate using the drive force to form the grooves of the scattering pattern to a depth ranging from 3 μm to 20 μm.

The teeth may include at least one group of teeth having a same pitch.

The teeth of the scraping part may be arranged such that the pitch thereof is successively reduced from a first end of the scraping part to a second end thereof.

Furthermore, a pitch between each adjacent two of the teeth may range from 0.2 mm to 2 mm.

The opposite ends of the scraping part may coincide with bottoms of the corresponding valleys of the teeth, and the teeth may include a number of teeth satisfying conditions that a sum of widths of the teeth be within a range of 10 mm and an absolute error value be minimized, and the sum of the widths of the teeth may define a width of a standardized unit scraper.

In addition, a plurality of standardized unit scrapers may be arranged in a line to form an entire scraper assy.

The teeth of the scraper assy may be arranged such that the pitch thereof is successively reduced from a first end to a second end of the scraper assy.

The scraper assy may include, from a first end to a second end thereof, a plurality of groups of unit scrapers, each of which has a same pitch. The groups of unit scrapers may be arranged in at least one manner selected from among a sequence from the group of unit scrapers having a largest pitch to the group of unit scrapers having a smallest pitch, and a reverse sequence, an alternating sequence, and a combined sequence.

Furthermore, each of the teeth may include a first scraping portion coming into contact with and scraping the light guide plate to form the scattering pattern, and a second scraping portion post-processing the scattering pattern formed by the first scraping portion.

The first scraping portion may have an angle ranging from 75° to 100°. The second scraping portion may have an angle ranging from 110° to 140°.

In another aspect, the present invention provides an apparatus for manufacturing a light guide plate using a scraper, including: a stage supporting the light guide plate thereon; a light-guide-plate transfer unit linearly moving the stage in an X-axis direction to transfer the light guide plate linearly; and a first scraper and a second scraper oriented in a direction perpendicular to the direction in which the light-guide-plate transfer unit linearly moves, the first scraper and the second scraper sharing portions of the light guide plate to be scraped to form a scattering pattern, each of the first and second scrapers coming into contact with the light guide plate and scraping the light guide plate to form grooves of the scattering pattern, each of the first and second scrapers having a scraper assy which includes a plurality of standardized unit scrapers each of which is moved upwards or downwards using a different intensity (kgf) of drive force. The scraper assy has teeth having at least two different pitches.

The scraper assy may be configured such that a pitch of the scattering pattern formed on the light guide plate is the greatest at the first end thereof closest to a light source, and such that the pitch of the scattering pattern is successively reduced as a location thereof moves farther away from the light source.

The scraper assy may be configured such that a pitch of the scattering pattern formed on the light guide plate is the greatest at the opposite first and second ends thereof closest to respective light sources, and such that the pitch of the scattering pattern is successively reduced from the opposite first and second ends of the light guide plate to a medial portion thereof farthest from the light source.

Furthermore, each of the standardized unit scrapers may generate a predetermined intensity (kgf) of drive force in direct proportion to the number of teeth.

The scraper assy may include, from the first end to the second end thereof, a plurality of groups of unit scrapers. Each of the groups of unit scrapers may have a same pitch. The groups of unit scrapers may be arranged in at least one manner selected from among a sequence from the group of unit scrapers having a largest pitch to the group of unit scrapers having a smallest pitch, and a reverse sequence, an alternating sequence, and a combined sequence.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view of a back light unit shown to illustrate the technique of the present invention;

FIG. 2 is a view illustrating the arrangement and construction of a light guide plate and a light source, according to an embodiment of the present invention;

FIG. 3 is a view illustrating the arrangement and construction of a light guide plate and light sources, according to a modification of the embodiment of the present invention;

FIG. 4 is a view illustrating a method of scraping the light guide plate to form a scattering pattern according to the embodiment of the present invention;

FIG. 5 is a view showing an example of a deformed light guide plate according to the embodiment of the present invention;

FIGS. 6A through 6C are of sectional views showing other examples of deformed light guide plates;

FIG. 7 is a view illustrating the construction and function of an active unit scraper assy according to the embodiment of the present invention;

FIG. 8 is a view illustrating pitches of the teeth provided on the standardized unit scraper assy according to the embodiment of the present invention;

FIGS. 9A through 9D are enlarged views of each tooth or the teeth of the scraper according to the embodiment of the present invention;

FIG. 10 is a view illustrating an angle at which the scraper comes into contact with the light guide plate according to the embodiment of the present invention;

FIG. 11 is a view illustrating the construction of an entire active scraper assy which includes standardized unit scrapers arranged in a line according to the embodiment of the present invention;

FIG. 12 is a perspective view of an apparatus for manufacturing light guide plates, according to an embodiment of the present invention; and

FIG. 13 is a block diagram showing the construction of the apparatus for manufacturing light guide plates according to the embodiment of the present invention.

### DETAILED DESCRIPTION

The terms and words used in the specification and claims are not necessarily limited to typical or dictionary meanings, but must be understood to indicate concepts selected by the inventor as the best method of illustrating the present invention, and must be interpreted as having meanings and concepts adapted to the scope and sprit of the present invention for understanding the technology of the present invention. In the following description, when it is determined that the detailed description for the conventional function and conventional structure confuses the gist of the present invention, the description may be omitted.

A kilogram-force (kgf) is a unit of force that indicates a magnitude of force and is a value obtained by multiplying one kilogram (kg) mass by its acceleration or the acceleration of gravity. 1 kgf is a value obtained when a body of 1 kg is measured on the earth. In other words, it is satisfied that 1 kgf=1 kg×9.8 m/s (the acceleration of gravity, standard gravity, a conventional value approximating the average magnitude of gravity on Earth)=9.8 N (Newton). If a body of 1 kg is measured on the moon, a different value will be obtained.

Information is classified into visual information, auditory information, olfactory information and tactile information. Devices for displaying visual information are classified into emissive display devices, such as CRTs, which emit light by themselves, and non-emissive display devices, such as LCDs, which cannot emit light by themselves and which use external light.

Non-emissive display devices need back light units (BLUs) for supplying light from the outside. The BLUs are classified into an edge lighting BLU which supplies light from the side edges of a display device and converts it into a surface light source, and a direct lighting BLU which supplies light from the entire area of a rear surface of a display device as a surface light source.

The term “effective area (effective screen)” refers to a region within which a user can effectively obtain visual information from a display unit, for example, an LCD, to which light is supplied from a back light unit as a surface light source.

The term “optical pattern” refers to a pattern which changes and controls a path of light in consideration of the fact that light is refracted, diffracted or reflected by a variety of scattering patterns.

The term “scattering pattern” refers to a pattern configured such that light is regularly or irregularly scattered over a desired region or portion using the optical pattern.

A scraper is a device for mechanically machining a target to form a selected pattern. The term “scraping” refers to machining the target using the scraper.

The term “assy” is an abbreviated form of “assembly” and refers to a single component which is manufactured by assembling several parts that are different or the same with each other in a predetermined manner. Hereinafter, because scrapers each of which is standardized as a single unit are arranged in a line and then assembled into a single body, the term “assy” refers to a scraper assy which is manufactured to have a predetermined length.

Springs provide moving force using the elasticity. There are many kinds of springs, for example, coil springs, plate springs, etc. Air cylinders generate a linear moving force using air. Oil cylinders generate a linear moving force using oil. Hereinafter, these cylinders will be described as being used as a moving force generating unit or a drive unit.

A white point is a point which is brighter than other points or is uncontrollable in brightness under conditions of constant brightness on a surface light source. When this phenomenon is represented as a line, this is called a white line. A point which is darker than other points and is contrary to that of the white point is referred to as a black point. Typically, the black point phenomenon is induced by impurities, such as chips. Hereinafter, such black points will be illustrated as falling within the meaning of white points.

The term “surface-unit drive force” refers to a force or drive force to be transmitted through a surface having a predetermined size. The term “line-unit drive force” refers to a drive force that is transmitted through a line having a predetermined length. The term “point-unit drive force” refers to the drive force that is transmitted through a point having a predetermined size.

A pitch is a distance between adjacent valleys or the peaks of a screw or saw teeth. In the present invention, the term “pitch” will be represented in the drawings as the distance between adjacent peaks for the sake of the description. Furthermore, in a pattern having the same repetitive shapes, the term “pitch” refers to a distance between adjacent shaped portions.

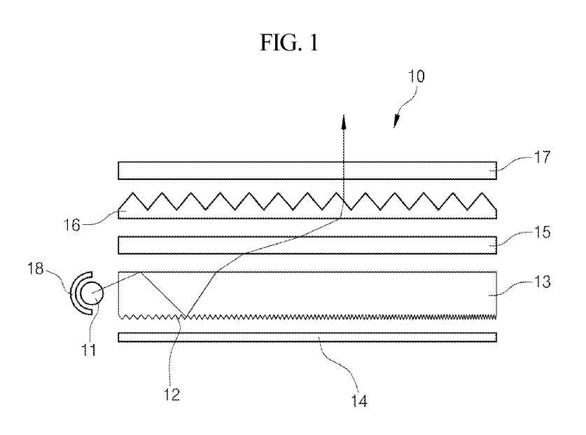

FIG. 1 is a sectional view of a back light unit shown to illustrate the technique of the present invention.

Hereinafter, the present invention will be described in detail with reference to the attached drawings. A back light unit 10 includes a light source 11, a light guide plate 13, a reflective sheet 14, a diffusion sheet 15, a prism sheet 16 and a DBEF (Dual Brightness Enhancement Film) 17. The light source 11 creates light and emits it. The light emitted from the light source 11 enters one edge of the light guide plate 13. The light guide plate 13 forms a surface light source using a scattering pattern 12 formed under a lower surface thereof so that the light that enters the light guide plate 13 is emitted therefrom in a light emitting manner of the surface light source. The reflective sheet 14 is provided under a lower surface of the light guide plate 13 to reflect light emitted through the lower surface of the light guide plate 13. The diffusion sheet 15 diffuses and disperses light emitted from an upper surface of the light guide plate 13 to make the brightness of the light uniform. The prism sheet 16 has a prism function which processes light that has passed through the diffusion sheet 15 such that the brightness of the light is increased on the front surface of the back light unit 10. The DBEF 17 protects the prism sheet 16 from external impact and is configured such that light that has passed through the prism sheet 16 passes through the DBEF 17 with reduced light loss. A reflector 18 is provided around the outside of the light source 11. The reflector 18 reflects light emitted from the light source 11 such that the light enters the edge of the light guide plate 13 without light leaking out.

In the back light unit 10 having the above-mentioned construction, light entering the edge of the light guide plate 13 from the light source 11 is repetitively total-reflected and refracted by the scattering pattern 12 to form the surface light source. Light which is emitted from the light guide plate 13 backwards is reflected by the reflective sheet 14 and thus goes towards the front surface of the back light unit 10.

The scattering pattern 12 is configured such that the pitch thereof is reduced in stages as it is farther away from the light source 11 to enhance the efficiency with which light is scattered. In other words, because light is more actively scattered as it goes farther away from the light source 11, the surface light source the brightness of which is uniform over the entire area thereof can be provided.

In the drawing, although the light source is illustrated as being provided on one edge of the light guide plate, light sources may be provided on respective both edges, all edges or a selected edge or edges of the light guide plate.

The surface light source that is formed by the above-mentioned method can be used in a flat panel display device, such as an LCD (liquid crystal display), which is non-emissive and is a light receiving style device, or in a lighting signboard, etc.

Screen printing, molding, cutting, etc. can be used as a method of forming the optical scattering pattern 12 in the light guide plate 13.

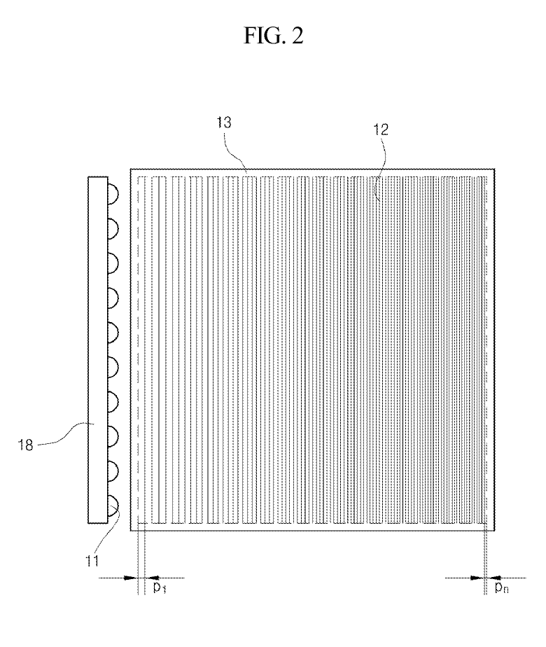

FIG. 2 is a view illustrating the arrangement and construction of the light guide plate and the light source according to the embodiment of the present invention.

Below this will be explained in detail with reference to FIG. 2. The reflector 18 is disposed on a corresponding side of the light source 11. The reflector 18 reflects light emitted from the light source 11 so that all of the light emitted from the light source 11 enters the edge of the light guide plate 13.

Light sources 11 may be disposed on both edges or all edges of the light guide plate 13. In this embodiment, the light source 11 is illustrated as being located on only one edge of the light guide plate 13.

The optical scattering pattern 12 formed on the corresponding surface of the light guide plate 13 is configured such that pitches p₁ through pₙ, thereof become larger as they pass closer to the light source 11 while the pitches p₁ through pₙ, become smaller as they go farther away from the light source 11.

The scattering pattern 12 may have a variety of shapes, for example, linear, oblique, wave, radial, Fresnel, etc. Furthermore, the scattering pattern 12 may have a shape deduced from these shapes, and two or more shapes may be combined to form the scattering pattern 12.

In an embodiment of the present invention, the scattering pattern is formed by cutting (hereinafter, referred to as ‘scraping’).

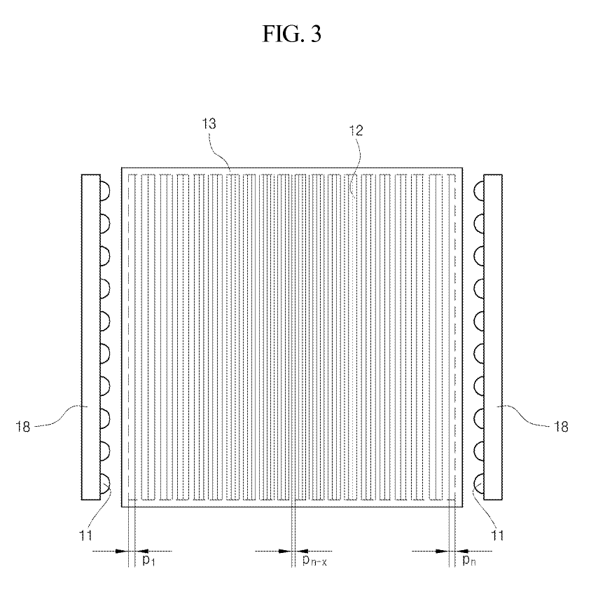

FIG. 3 is a view illustrating the arrangement and construction of a light guide plate and light sources, according to a modification of the embodiment of the present invention.

Hereinafter, this will be explained in detail with reference to FIG. 3. In this embodiment, a light source 11 and a reflector 18 are located on each of opposite edges of the light guide plate 13. In this embodiment, light emitted from the light sources 11 enters the opposite edges of the light guide plate 13.

The optical scattering pattern 12 formed on the corresponding surface of the light guide plate 13 is configured such that the pitches p₁ and pₙ, on the opposite edges of the light guide plate 13 which are adjacent to the respective light sources 11 are equal to each other and are largest, and the pitch pₙ₋ₓ of a medial portion of the light guide plate 13 which is farthest from the opposite light sources 11 is the smallest.

In the same manner, the scattering pattern 12 may adopt one or more selected from among a variety of shapes, for example, linear, oblique, wave, radial, Fresnel, etc. According to an embodiment of the present invention, the scraping method is used to form the scattering pattern 12 having a linear shape.

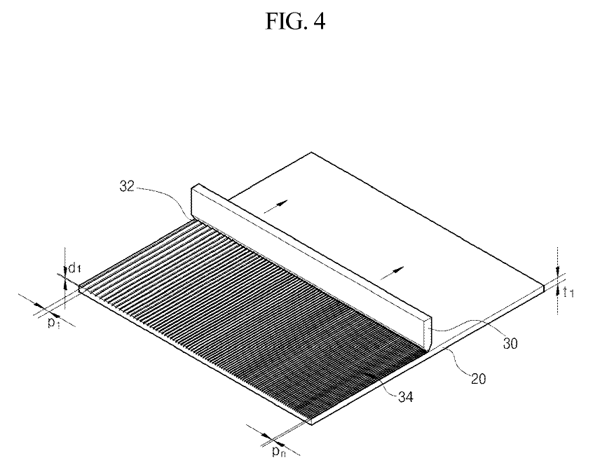

FIG. 4 is a view illustrating a method of scraping the light guide plate to form the scattering pattern according to the embodiment of the present invention.

Below this will be described in detail with reference to FIG. 4. A scraper 30 is located on one side of the corresponding surface of the light guide plate 20 which has a predetermined length and width and is planar or flat. Thereafter, the scraper 30 is linearly moved over the surface of the light guide plate 20 in the direction designated by the arrow.

A plurality of teeth 32 having certain pitches and depths is formed in a lower end of the scraper 30 which comes into contact with the surface of the light guide plate 20 while the scraper 30 moves over the light guide plate 20.

Each tooth 32 may have a circular or polygonal tip, for example, a triangular tip.

Furthermore, the pitch p₁, pₙ, which is a distance between adjacent teeth 32 may range from 0.2 mm to 2 mm.

In the embodiment, the pitch p₁ is largest, which is defined by the corresponding teeth 32 that forms the scattering pattern 34 on the portion of the light guide plate 20 that is closest to the light source. The pitch pₙ, is smallest, which is defined by the corresponding teeth 32 that form the scattering pattern 34 on the portion of the light guide plate 20 that is farthest from the light source.

The teeth 32 may have a predetermined depth such that valleys each of which has a depth d₁ ranging from 3 μm to 20 μm are formed in the light guide plate 20 by scraping.

The scraper 30 applies a predetermined pressure (kgf) to the light guide plate 20 in the vertical direction using a moving force generating part (not shown) and is linearly moved in the direction of the arrow along the surface of the light guide plate 20 by a linear moving member (not shown). Therefore, the depth d₁ of the valleys of the scattering pattern 34 formed on the light guide plate 20 by scraping can be uniform.

In the drawings, the light guide plate 20 is illustrated as being ideally flat.

Meanwhile, the light guide plate 20 has a thickness t₁ ranging from 1 mm to 4 mm, for example, of 2 or 3 mm.

Furthermore, the light guide plate 20 is, but not limited to, made of PMMA (poly-methyl-methacrylate) acryl resin.

In the embodiment, the light guide plate 20 is formed at a constant thickness t₁ by extruding PMMA acryl resin using an extrusion mold.

Here, the light guide plate 20 may be easily deformed depending on various factors, for example, extrusion conditions, such as the temperature of the extrusion mold, duration of extrusion, a period of extrusion, etc., the gravity applied to the light guide plate 20 which is being extruded, tensile force applied to an extrudate, extrusion rollers for transferring the extruded light guide plate 20, the time taken to cool the extrudate, etc.

Furthermore, while the extruded light guide plate 20 which is relatively thin is placed and stored on a rack, the light guide plate 20 may be deformed depending on a variation in humidity or temperature of the storage place or a storage duration, or because the surface of the rack is uneven.

Due to such a deformation, the light guiding plate 20 may be bent or the thickness thereof may be uniform, resulting in deteriorating flatness.

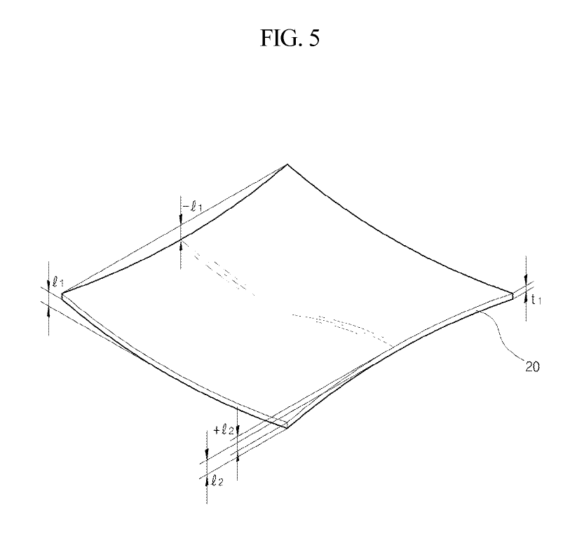

FIG. 5 is a view showing an example of a deformed light guide plate according to the embodiment of the present invention.

One example of the deformed light guide plate will be explained with reference to FIG. 5. The light guide plate 20 is formed by extruding a PMMA acryl resin plate having a thickness t1 ranging from 1 mm to 4 mm using an extrusion mold. According to an embodiment of the present invention, the light guide plate 20 is formed using a plate having a thinness t of 3 mm.

PMMA acryl resin extruded from the extrusion mold is in a high-temperature semi-liquid state. While the extruded PMMA acryl resin passes through the extrusion rollers, the temperature thereof is reduced so that it is stabilized and solidified to form a plate to be used as the light guide plate 20.

Because the thickness t1 of the light guide plate 20 which is being extruded in the semi-liquid state from the extrusion mold ranges from 1 mm to 4 mm, it may be easily deformed, for example, expanded, lumped, bent, etc., by a variety of factors, for example, extrusion conditions including the temperature of the extrusion mold and duration of extrusion, the time taken to cool the extruded light guide plate 20, the gravity, the humidity and temperature of a place where the extrusion is conducted, and conditions and surroundings of a place where the light guide plate 20 is placed and stored on the rack.

Even if such deformation is very slight, the light guide plate 20 cannot become flat. If the degree of deformation is similar to or greater than the depth of the scattering pattern to be formed on the surface of the light guide plate 20, the formed scattering pattern may be defective.

As such, the light guide plate 20 formed in a rectangular shape having a predetermined size may be deformed, for example, it may be slightly uneven or be bent. Typically, the uneven or bent portions of the light guide plate 20 have a height difference ranging from 10 μm to 150 μm, compared to the normal case which is ideally flat.

The depth of the grooves of the scattering pattern 34 which are formed by scraping the light guide plate 20 using the teeth 32 provided on the lower end of the scraper 30 ranges from 3 μm to 20 μm.

Therefore, in the case of the light guide plate 20 of the embodiment, the scattering pattern 34 cannot be normally formed on the portions on which height differences relative to the reference surface are induced, thus being defective.

For example, in the case of FIG. 5, when the opposite edges of the light guide plate 20 which is in the normal state are set as the reference, a medial portion of a left edge of the light guide plate 20 sags downwards by a distance of −l₁ with respect to the reference. Thereby, the scattering pattern can be formed on both ends of the left edge but cannot be formed on the medial portion thereof, resulting in a defect.

Furthermore, in the case of a right edge of the light guide plate 20, a medial portion protrudes upwards by a distance of +l₂. Therefore, the scattering pattern is formed only on the medial portion, or excessive pressure is applied to this portion, so that the scattering pattern may not be normally formed, thus resulting in a defect.

In the drawing, as one example, although the medial portion of each edge of the light guide plate 20 has been illustrated as sagging downwards by the distance of −l₁ or protruding upwards by the distance of +l₂ with respect to the opposite edges of the light guide plate 20 when the light guide plate 20 is in the normal state, some portions may be expanded and become thin or make a lump and become thick. It will be easily understood that these phenomena may be combined and the light guide plate 20 may be deformed in various shapes.

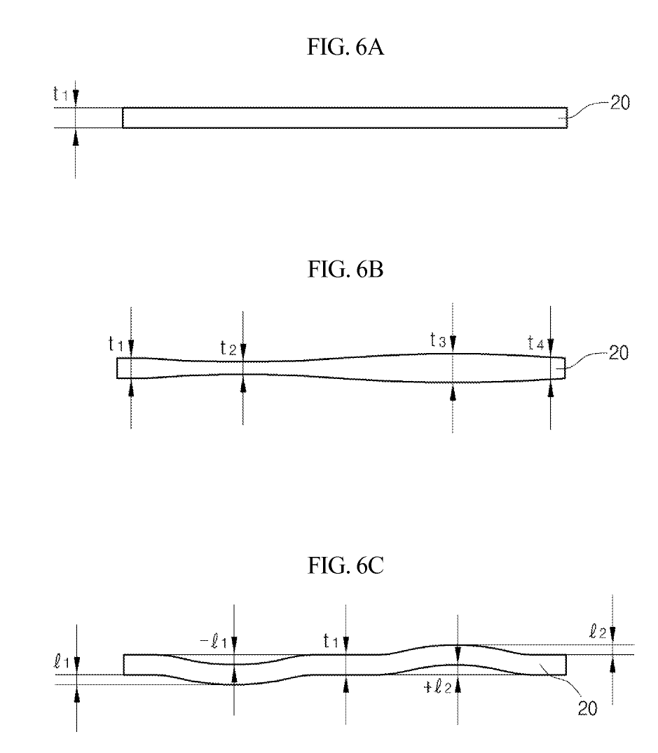

FIGS. 6A through 6C are of sectional views showing other examples of deformed light guide plates.

Referring to FIG. 6A, the sectional view of FIG. 6A illustrates a normal light guide plate 20 which is ideally flat and has a uniform thickness t1.

However, actually, the thickness t of the extruded light guide plate 20 may be non-uniform, as shown in FIGS. 6B and 6C.

In other words, when the light guide plate 20 is formed by extruding to have a thickness of t₁, because of various reasons, such as gravity, extruding strength, tensile force, the temperature of the mold, etc., and depending on surrounding conditions, a portion of the light guide plate 20 may have a thickness, for example, t₂, less than the thickness t₁, may have a thickness, for example, t₄, slightly greater than the thickness t₁, or may make a lump and thus have a thickness, for example, t₃, much greater than the thickness t₁. As such, the light guide plate 20 may be deformed and be non-uniform in thickness.

Furthermore, as shown in the sectional view of FIG. 6C, although the extruded light guide plate has a constant thickness of t1, the light guide plate may be bent or curved so that its portions may become higher or lower than the reference surface.

In other words, the light guide plate 20 may be bent depending on extrusion conditions or storage conditions. A portion of the light guide plate 20 may be bent downwards by a distance of −l₁ or bent upwards by a distance +l₂. As such, the light guide plate 20 may not become level. That is, the light guide plate 20 may be deformed and thus become not flat.

Meanwhile, in the light guide plate 20 which is actually extruded and placed on the rack, styles of deformation shown by the views of FIGS. 6B and 6C are combined so that it is very irregularly deformed.

If numerical values pertaining to such a deformation are greater than the depths of the grooves of the scattering pattern that range from 3 μm to 20 μm, the scattering pattern cannot be formed by scraping.

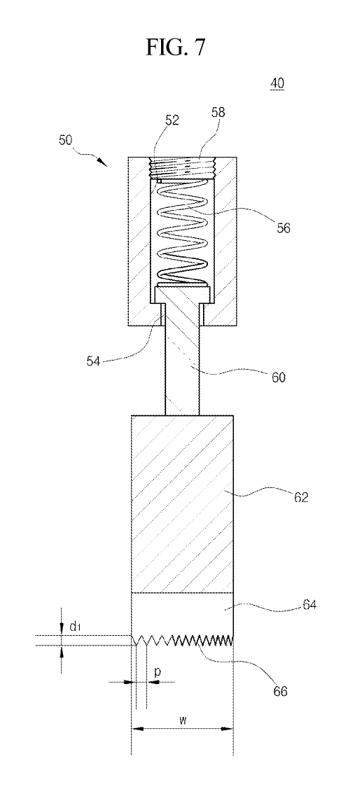

FIG. 7 is a view illustrating the construction and function of an active unit scraper according to the embodiment of the present invention.

Hereinafter, this will be explained in detail with reference to FIG. 7. In this embodiment, each active unit scraper 40 of an active scraper assy includes a drive-force generating part 50, a transmitting part 60, a body part 62 and a scraping part 64.

The drive-force generating part 50 has a first hole 52, a second hole 54, a drive unit 56 and a stopper 58.

The unit scraper 40 of the present invention traces the bent or curved surface of the light guide plate using a drive force acting in the vertical direction while it scrapes the light guide plate. Therefore, the unit scraper 40 is called an active unit scraper.

The first hole 52 has a cylindrical shape of a constant diameter. A first end of the first hole 52 is completely open, and a second end thereof is partially open and communicates with the second hole 54.

The second hole 54 communicates with the first hole 52 and has a cylindrical shape the diameter of which is less than that of the first hole 52. Both ends of the second hole 54 are completely open.

Each of the first and second holes 52 and 54 may have a tubular shape the cross-section of which has one shape selected from among a circular shape and polygonal shapes including a triangular shape. Desirably, the first and second holes 52 and 54 have cylindrical shapes.

The drive unit 56 is installed in the first hole 52 and generates a predetermined intensity (kgf) of drive force in the linear direction.

The drive unit 56 is a unit for generating drive force in the linear direction and may include one selected from among a variety of drive-force generating devices including a coil spring, a plate spring, an air cylinder, an oil cylinder, etc.

In this embodiment shown by the drawing, a coil spring is used as the drive unit 56.

The stopper 58 is fastened to the first end of the first hole 52 that is completely open. The stopper 58 functions to prevent the drive unit 56 from being undesirably removed from the first hole 52.

The transmitting part 60 transmits a predetermined intensity (kgf) of drive force generated by the drive unit 56 that includes the coil spring to the body part 62.

The body part 62 converts the predetermined intensity (kgf) of linear drive force transmitted from the transmitting part 60 into surface-unit drive force using the standardized width and area greater than transmitting part 60. The body part 62 transmits the drive force to the scraping part 64 which is coupled to the lower end of the body part 62 with the same width as that of the body part 62.

In the embodiment of the drawing, the scraping part 64 has a triangular cross-section and converts a surface-unit drive force transmitted from the body part 62 into line-unit drive force.

Teeth 66 having predetermined pitches and depths are formed on the end of the scraping part 64.

A pitch p between adjacent teeth 66 ranges from 0.2 mm to 2 mm, and the pitch p between adjacent teeth 66 is successively and slightly reduced from one side of the scraping part 64 to the other side thereof.

Furthermore, the teeth 66 may be configured such that the same pitch is given as a unit of group. According to an embodiment of the present invention, each group has two or three adjacent teeth 66. Alternatively, all the teeth 66 provided on the standardized unit scraper 40 may have the same pitch.

A depth d₁ of each of valleys defined by the teeth 66 ranges from 3 μm to 20 μm.

In this specification, the depth d₁ defined by the teeth 66 is illustrated as being the same as the depth d₁ of the scattering pattern formed on the light guide plate 20.

The scattering pattern which is formed by the teeth 66 having the above-mentioned pitch and depth is adapted to scatter incident light very widely.

Furthermore, the width w of the standardized unit scraper 40 is approximately 10 mm and may be increased or reduced within a predetermined error range.

The opposite ends of the scraping part 64 of the standardized unit scraper 40 of an embodiment of the present invention coincide with the bottoms of the corresponding valleys of the teeth 66. The width w of the unit scraper 40 is the same as the sum of all pitches p and, for example, is about 10 mm.

According to an embodiment of the present invention, the width w of the unit scraper 40 is determined as the sum of all the pitches of the teeth 66 that are defined based on the valleys within a range which allows the minimum error defined by the absolute value.

In other words, the opposite ends of the scraping part 64 of each unit scraper 40 coincide with the bottoms of the corresponding valleys of the teeth 66, and the sum of all the pitches of the teeth 66 becomes the width w of the unit scraper 40. Therefore, the width w of each standardized unit scraper 40 may have an error within a predetermined range defined by the absolute value.

Furthermore, it is desirable that an error of the width w be minimized as the absolute value with reference to the reference value.

To form the scattering pattern with a constant desired depth on the light guide plate 20 in such a way as to scrape the light guide plate 20 using the teeth 66, the intensity (kgf) of pressure per unit area or drive force may be in direct proportion to the number of teeth 66.

The drive unit 56 of the drive-force generating part 50 is used as a unit for providing the predetermined intensity (kgf) of drive force.

In an embodiment for the sake of comprehension of the present invention, the drive unit 56 is configured such that a drive force of 2 kgf is provided per ten teeth 66. If twenty teeth 66 are provided on the unit scraper 40, the drive unit 56 provides a drive force of 4 kgf If thirty teeth 66 are provided on the unit scraper 40, the drive unit 56 provides a drive force of 6 kgf.

In this embodiment, although the drive unit 56 has been illustrated as being configured such that the intensity of the drive force is in direct proportion to one unit per ten teeth 66, the drive unit 56 may be configured such that the intensity of the drive force is in direct proportion to one unit per single tooth 66.

As such, the drive unit 56 increases the intensity (kgf) of drive force as the number of teeth 66 increases, and it reduces the intensity (kgf) of the drive force as the number of teeth 66 gets smaller.

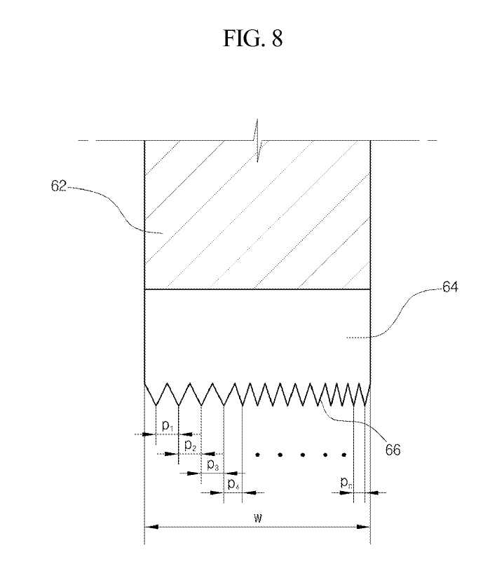

FIG. 8 is a view illustrating pitches of the teeth provided on the standardized unit scraper according to the embodiment of the present invention.

Referring to FIG. 8, the teeth 66 provided on the lower end of the scraping part 64 of the unit scraper are configured such that the pitch thereof reduces from one side of the scraping part 64 to the other side thereof.

In this embodiment, the pitch between the leftmost (first) tooth 66 and the adjacent (second) tooth 66 is designated by ‘p₁’. The pitch between the second and third teeth 66 is designated by ‘p₂’, and the remaining pitches are successively designated by ‘p₃’, ‘p₄’, and so on. Finally, the pitch between the rightmost tooth 66 and the adjacent tooth 66 is designated by ‘pₙ’.

In the drawing, although a distance between the adjacent peaks of the teeth 66 is illustrated as referring to the pitch, a distance between the adjacent valleys of the teeth 66 may refer to the pitch.

Although the pitches p₁ to pₙ of the teeth 66 may be configured such that they successively increase, in this embodiment, the pitches p₁ to pₙ are illustrated as being configured such that they get successively smaller in a manner of ‘p₁>p₂>p₃> . . . >pₙ’.

The unit of decrementation of these pitches of the teeth 66 may be a very small value of several or several tens micrometers (μm).

As another embodiment, the teeth 66 may be divided into several groups, and the teeth 66 of each group may have the same pitch.

In the case where the opposite ends of the scraping part 64 of the standardized unit scraper 40 coincide with the bottoms of the corresponding valleys of the teeth 66, the width w of the unit scraper 40 is the same as the sum of all pitches of the teeth 66. Although the width w of the unit scraper 40 may vary within a predetermined range, in the embodiment of the present invention, the width w of the unit scraper 40 is illustrated as being standardized.

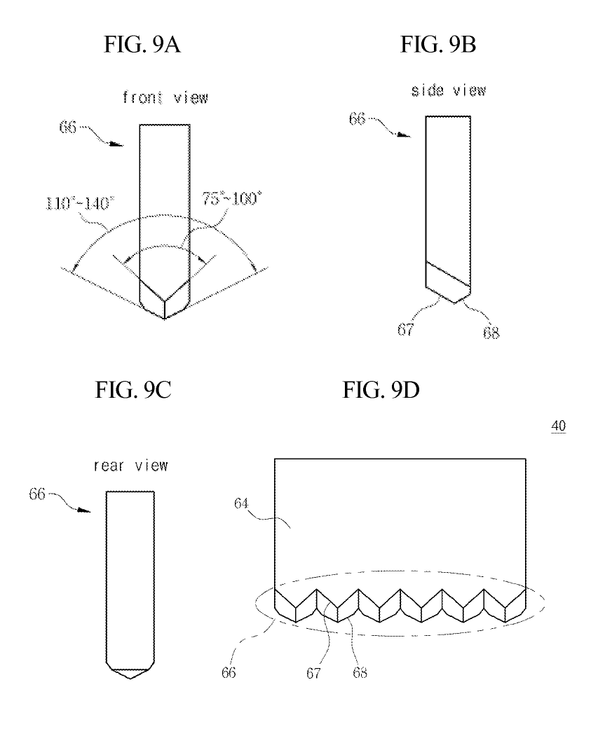

FIGS. 9A through 9D are enlarged views of each tooth or the teeth of the scraper according to the embodiment of the present invention.

FIG. 9A is a front view of each tooth 66. FIG. 9B is a side view of the tooth 66. FIG. 9C is a rear view of the tooth 66. FIG. 9D is a front view of a scraping part 64 having teeth 66.

Each tooth 66 includes a first scraping portion 67 and a second scraping portion 68.

When the unit scraper 40 scrapes the light guide plate 20, the first scraping portion 67 first comes into contact with the light guide plate 20, thus primarily forming the scattering pattern.

The second scraping portion 68 is located at a position opposite the first scraping portion 67. The second scraping portion 68 post-processes or secondarily machines the scattering pattern which has been machined by the first scraping portion 67.

Furthermore, the first scraping portion 67 is integrally formed with the second scraping portion 68 so that the scattering pattern can be post-processed by the second scraping portion 68 just after it has been primarily formed.

According to an embodiment of the present invention, as shown in FIG. 9A, an angle defined by an edge of the first scraping portion 67 is less than an angle defined by an edge of the second scraping portion 68.

For example, the edge of the first scraping portion 67 is angled at an angle ranging from 75° to 100°, and the edge of the second scraping portion 68 is angled at an angle ranging from 110° to 140°.

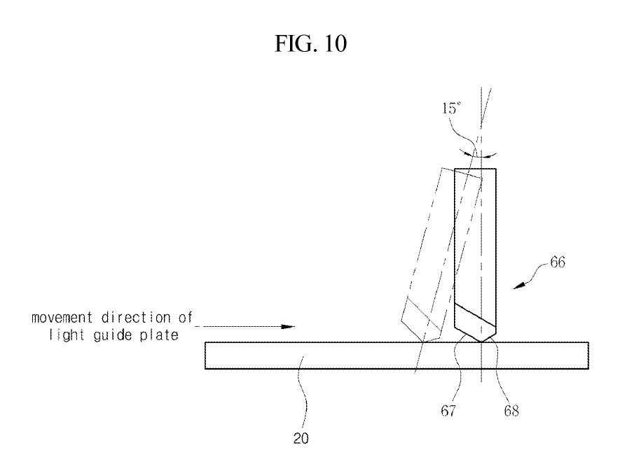

FIG. 10 is a view illustrating an angle at which the scraper comes into contact with the light guide plate according to the embodiment of the present invention.

Referring to FIG. 10, the unit scraper 40 can be oriented perpendicular to the light guide plate 20, unlike in the conventional technique.

Furthermore, a center axis of the unit scraper 40 is inclined at an angle from 0° to 15° with respect to the vertical line perpendicular to the light guide plate 20 (at an angle from 75° to 90° with respect to the surface of the light guide plate 20) in a direction opposite to the direction in which the light guide plate 20 moves.

As mentioned above, the angle of the edge of the first scraping portion 67 of each tooth 66 is less than that of the second scraping portion 68. Such teeth 66 scrape the light guide plate 20 to form the scattering pattern.

The first scraping portion 67 the edge of which has a smaller angle first scrapes the light guide plate 20 to form the scattering pattern, and the second scraping portion 68 the edge of which has an angle greater than that of the first scraping portion 67 post-processes the light guide plate 20 so that protrusions remaining on the scattering pattern after the first scraping portion 67 passed therethrough are removed by the second scraping portion 68.

In the unit scraper 40 according to the embodiment of the present invention, the edge of the second scraping portion 68 of each tooth 66 coming into contact with the light guide plate 20 is formed such that it has a predetermined angle, as shown in the front view of FIG. 9A.

As shown in the side view of the tooth 66 of FIG. 9B, it is to be understood that the angle of the edge of the second scraping portion 68 is greater than that of the first scraping portion 67.

The edge of the second scraping portion 68 removes protrusions that remain around the scattering pattern after it has been machined by the first scraping portion 67. When the edge of the second scraping portion 68 machines the light guide plate 20, the protrusions are separated from the light guide plate 20 in a shape of a thin thread like that of a spider.

In other words, when the light guide plate 20 is primarily machined by the first scraping portion 67 to form the scattering pattern, protrusions are formed on opposite sides of the pattern. These protrusions are removed from the light guide plate 20 when the second scraping portion 68 secondarily machines the light guide plate 20.

When the protrusions are removed from the light guide plate 20, they are separated from the light guide plate 20 in a shape of a continuous thin thread like that of a spider rather than being separated therefrom in a shape of small pieces like chips. Therefore, the removed protrusions are prevented from remaining on the light guide plate 20, unlike when the protrusions are removed from the light guide plate 20 in the shape of small pieces like chips. Thus, there is an effect similar to that when dust collection is performed.

The depth of grooves of the scattering pattern which are formed on the light guide plate 20 by scraping ranges from 3 μm to 20 μm and, for example, it is generally about 10 μm.

That is, protrusions to be removed also have widths of several micrometers. Thus, in the conventional technique, when the protrusions are separated from the light guide plate 20, they may become very small pieces of chips which are invisible.

In the embodiments of the present invention, such protrusions which are formed around the pattern while the primary machining process is performed to form the scattering pattern can be completely and reliably removed from the light guide plate 20 in a shape of a continuous thread like that of a spider during the secondary machining process.

Therefore, the unit scraper 40 according to the embodiment of the present invention can clearly remove protrusions formed on the light guide plate 20 during the process of forming the scattering pattern. In addition, the unit scraper 40 of the embodiments of the present invention can prevent impurities, such as chips, from remaining on the scattering pattern after the process.

Furthermore, the embodiments of the present invention can prevent the reflective sheet 14 from being scratched by protrusions or chips. Moreover, the embodiments of the present invention markedly reduce a white point phenomenon which may be induced on the produced light guide plate by chips acting as impurities.

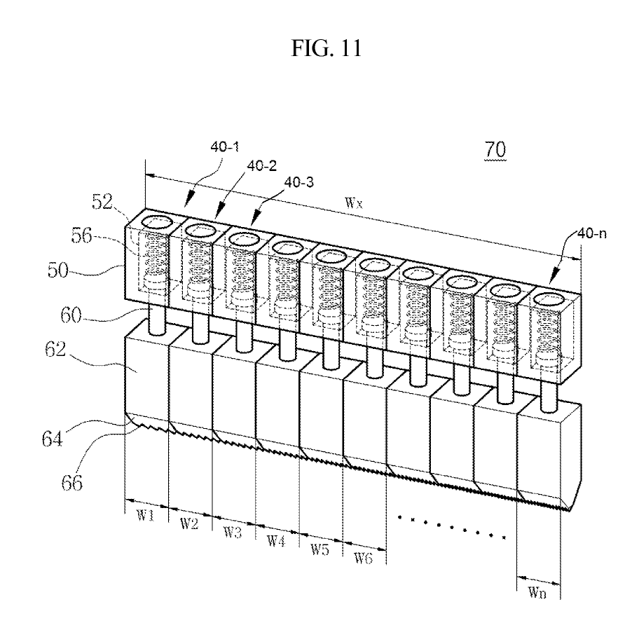

FIG. 11 is a view illustrating the construction of an entire active scraper assy which includes standardized unit scrapers arranged in a line according to the embodiment of the present invention.

Referring to FIG. 11, the active scraper assy 70 includes a plurality of active unit scrapers 40 which are arranged in a line and each of which is standardized.

The standardized unit scrapers 40 have teeth 66 the pitches of which are successively increased or reduced.

In this embodiment of the present invention, as shown in the drawing, the pitch p is successively reduced from a leftmost tooth 66-1 of a first unit scraper 40-1 (w1) to a rightmost tooth 66-n of a unit scraper 40-n (wn) which is located at an ‘n’-th position via a second unit scraper 40-2 (w2), a third unit scraper 40-3 (w3) and so on.

Here, the opposite ends of the scraping part 64 of each standardized unit scraper 40 coincide with the bottoms of the corresponding valleys of the teeth 66. Thus, the sum of pitches of the teeth 66 of each unit scraper 40 is the same as the width of the unit scraper 40.

Therefore, the width w1 of the first standardized unit scraper 40-1, the width w2 of the second standardized unit scraper 40-2, the width w3 of the third standardized unit scraper 40-3 and the width wn of the n-th standardized unit scraper 40-n may differ from each other within the minimum error range defined by the absolute value.

Furthermore, each standardized unit scraper 40 has the drive unit 56 of the drive-force generating part 50 which is configured such that the intensity (kgf) of drive force generated by the drive unit 56 is in direct proportion to the number of teeth 66.

In other words, regardless of the number of teeth 66, the unit scraper 40 is configured such that a uniform intensity of drive force is applied to each tooth 66.

The reason for that the pitches of teeth 66 differ from each other is that because the brightness of light entering a portion of the light guide plate 20 which is adjacent to the light source is comparatively high, the degree of scattering light must be reduced, and because the brightness of light entering a portion of the light guide plate 20 which is far from the light source is comparatively low, the degree of scattering light must be increased, so that a surface light source having uniform brightness on the whole can be formed.

The pitch of the portion of the scattering pattern that is formed on the light guide plate 20 at a position closest to the light source must have the maximum value within an allowed range. The pitch of the corresponding tooth 66 must be the largest.

As the pitch of each tooth 66 increases, the number of teeth 66 formed on a single unit scraper 40 is reduced. As the pitch of each tooth 66 is reduced, the number of teeth 66 formed on a single unit scraper 40 increases.

In an embodiment of the present invention, the allowed value of the pitch of each tooth 66 ranges from 0.2 mm to 2 mm.

Furthermore, the pitch of the portion of the scattering pattern that is formed on the light guide plate 20 at a position farthest from the light source must have the minimum value within the allowed range. The pitch of the corresponding tooth 66 must be the smallest. Therefore, the number of teeth 66 formed on the corresponding unit scraper 40-n is the largest.

Alternatively, as the design of the scattering pattern, pitches p₁, p₂, p₃, . . . pₙ, of each unit scraper 40 may be set as a unit of group such that the pitches of the groups are successively reduced or increased.

Furthermore, the teeth 66 may be arranged such that values of pitches alternate or are regularly or irregularly combined. As a further alternative, the teeth 66 may be arranged such that the pitch of the medial portion of the light guide plate 20 is smallest and the pitches of portions adjacent to both edges of the light guide plate 20 are the largest or are formed in a reverse manner.

Moreover, two or more of these several arrangement methods may be combined.

The teeth 66 must apply uniform pressure to the light guide plate 20 using a drive force to form the scattering pattern having grooves with depths ranging from 3 μm to 20 μm in the light guide plate.

In the embodiment of the present invention, the coil spring 56 is used to generate such a drive force. As stated above, for example, one selected from among a plate spring, an air cylinder, an oil cylinder may be used.

As illustrated in detail in the description of FIG. 7, a drive force must be generated such that uniform intensity (kgf) of force is applied to each tooth 66.

Therefore, the coil spring 56 installed in the first hole 52 of the unit scraper 40 may include a coil spring appropriate to generate drive force of intensity (kgf) in direct proportion to the number of teeth 66 formed with the standardized width w.

The linear drive force generated by the coil spring 56 is applied to the body part 62 by the transmitting part 60 and then transmitted to the teeth 66 provided on the lower end of the scraping part 64. The teeth 66 scrape the light guide plate using the drive force to form the scattering pattern.

The entire width wₓ of the scraper assy 70 may be changed depending on the size of the light guide plate 20 and, for example, ranges from 400 mm to 820 mm Moreover, it may be extended to a length greater than 1,000 mm.

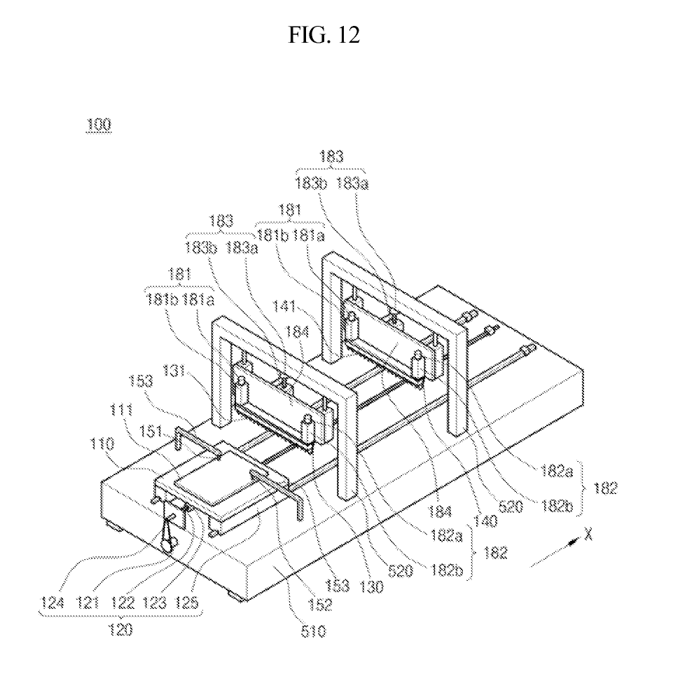

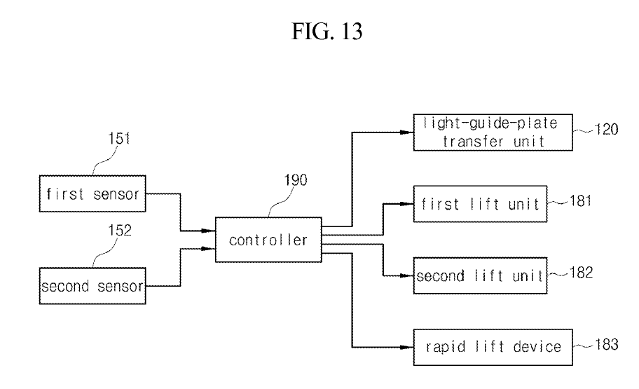

FIG. 12 is a perspective view of an apparatus for manufacturing light guide plates, according to an embodiment of the present invention. FIG. 13 is a block diagram showing the construction of the apparatus for manufacturing light guide plates according to the embodiment of the present invention.

Referring to FIGS. 12 and 13, the apparatus 100 for manufacturing light guide plates according to the embodiment of the present invention forms a scattering pattern on a light guide plate 111, in detail, forms the scattering pattern in the X-axis direction in which the light guide plate 111 is transferred. The apparatus 100 includes a stage 110 on which the light guide plate 111 is supported, a light-guide-plate transfer unit 120 which linearly moves the stage 110, and a first scraper 130 and a second scraper 140 which are arranged on the path along which the light guide plate 111 moves. The first and second scrapers 130 and 140 respectively include teeth 131 and 141 which scrape corresponding portions of the light guide plate 111 to form the scattering pattern on the light guide plate 111.

According to an embodiment of the present invention, the stage 110 holds the light guide plate 111 using a holder such as clamp which is provided on the upper surface of the stage 110. To minimize damage to the light guide plate 111 when it is supported on the stage 110, the holder may include vacuum holes (not shown) which are formed through the upper surface of the stage 110 and connected to an external vacuum device so that the stage 110 chucks the light guide plate 111 using a vacuum force.

The light-guide-plate transfer unit 120 is installed on a table 510 and functions to linearly move the stage 110 to transfer the light guide plate 111. For this, a hydraulic or pneumatic cylinder may be used. In this embodiment, the light-guide-plate transfer unit 120 is illustrated as using the drive force of a motor to transfer the stage 110.

In detail, the light-guide-plate transfer unit 120 includes a drive motor 121 which generates rotational force, a lead screw 122 which is rotated by the rotational force of the drive motor 121, and a ball screw 123 which is threaded over the lead screw 122 and fastened to the stage 110.

The drive motor 121 includes a motor, such as a servo motor or a step motor, which can control the distance that the light guide plate 111 is transferred. The rotational force is transmitted from the drive motor 121 to the lead screw 122 by a belt 124 or the like.

An external thread is formed on the outer circumferential surface of the lead screw 122. The lead screw 122 is oriented such that the longitudinal direction thereof is parallel to the direction in which the light guide plate 111 is transferred.

The ball screw 123 is fastened to the stage 110 and threaded over the lead screw 122. Thus, the ball screw 123 is linearly moved by the rotation of the lead screw 122 so that the stage 110 is transferred.

The light-guide-plate transfer unit 120 further includes a pair of guides 125 which are installed on opposite sides of the stage 110 and are parallel to the lead screw 122. The guides 125 guide the stage 110 and maintain it in the level state when the stage 110 is transferred.

The first scraper 130 and the second scraper 140 are installed in the directions perpendicular to the path along which the light guide plate 111 is transferred. The first and second scrapers 130 and 140 are arranged along the transfer path and are parallel to each other. The first and second scrapers 130 and 140 respectively have teeth 131 and 141 which come into line contact with and scrape the light guide plate 111 which is being transferred by the light-guide-plate transfer unit 120. The teeth 131 and 141 share portions of the light guide plate 111 to be scraped to form the scattering pattern on the light guide plate 111.

In other words, the light guide plate 111 that is moving consecutively comes into line contact with the first scraper 130 and the second scraper 140, so that the shared portions of the scattering pattern are formed in steps by the first and second scrapers 130 and 140. Thereby, the entire scattering pattern is completed.

In this embodiment, although the first and second scrapers 130 and 140 are provided in a pair, the present invention is not limited to this. That is, three or more scrapers may be provided.

Furthermore, each of the first and second scrapers 130 and 140 includes a plurality of scraping parts 64. Each scraping part 64 has teeth 66 which come into direct contact with the light guide plate 111 and scrape it to form the scattering pattern. Each scraping part 64 functions to support the corresponding teeth 66.

Each tooth 66 has a first scraping portion 67 which first scrapes the light guide plate 111 to form the scattering pattern, and a second scraping portion 68 which is located at a position opposite to the first scraping portion 67 and post-processes the scattering pattern which has been formed by the first scraping portion 67.

The post-process using the second scraping portion 68 includes secondarily scraping the scattering pattern which has been formed by the first scraping portion 67. The post-process makes the depth and width of the scattering pattern uniform, makes the shape of the scattering pattern clear, and removes protrusions and impurities, such as chips, which may be present in grooves of the formed scattering pattern or around opposite sides of the grooves.

Furthermore, the first scraping portion 67 is integrally formed with the second scraping portion 68 so that the forming of the scattering pattern and the post-processing are conducted at the same time.

An angle defined by an edge of the first scraping portion 67 may be less than an angle defined by an edge of the second scraping portion 68.

This embodiment is characterized in that the angle of the edge of the first scraping portion 67 ranges from 75° to 100°, and the angle of the edge of the second scraping portion 68 ranges from 110° to 140°.

As such, because the angle of the edge of the first scraping portion 67 of each tooth 66 is less than that of the second scraping portion 68, when the tooth 66 scrapes the light guide plate 111 to form the scattering pattern, protrusions which protrude on opposite sides of a groove of the scattering pattern formed by the first scraping portion 67 are successively post-processed by the second scraping portion 68 having the larger edge angle, thus being removed. Furthermore, impurities, such as chips, which may be present in the formed groove of the scattering pattern can be removed therefrom.

Each of the first and second scrapers 130 and 140 is oriented such that an angle of a center axis thereof relative to the surface of the light guide plate 111 ranges from 75° to 90° in the direction of the second scraping portion 68.

Thereby, the reflective sheet can be prevented from being scratched by the protrusions or impurities, such as chips, which may be induced when the scattering pattern is formed on the light guide plate 111.

Furthermore, when the protrusions are removed by the second scraping portion 68, they are separated from the light guide plate 111 in a continuous thread shape like that of a spider. Thus, the removed protrusions can be prevented from remaining in the formed scattering pattern as impurities, such as chips. Therefore, the present invention can reliably prevent a defective product in which a white point is formed by impurities, such as chips, remaining on the light guide plate.

As illustrated in detail in the description of FIG. 11, each of the first and second scrapers 130 and 140 includes a scraper assy 70 which includes a plurality of unit scrapers 40 which are arranged in a line. Each unit scraper 40 is standardized and linearly moves in the vertical direction using a predetermined intensity (kgf) of drive force generated by a coil spring 56.

In the following description, each of the first and second scrapers 130 and 140 will be regarded as comprising the scraper assy 70.

Therefore, even if the light guide plate is not flat, the first and second scrapers 130 and 140 each of which includes the scraper assy 70 can move along the curved surface of the light guide plate while scraping it and thus form grooves of the scattering pattern on the light guide plate to a uniform depth.

According to an embodiment of the present invention, when the scattering pattern is formed on the light guide plate 111, if each of the first and second scrapers 130 and 140 can maintain the state of being level with the light guide plate 111, the uniformity in the depth of grooves of the scattering pattern can be enhanced, and the formed scattering pattern can have a precise shape. For this, the apparatus further includes first and second lift units 181 and 182, first and second sensors 151 and 152 and a controller 190. The first and second lift units 181 and 182 are connected to each of the first and second scrapers 130 and 140 and control the inclination of the corresponding scraper 130, 140. The first and second sensors 151 and 152 are installed on the path along which the light guide plate 111 is transferred. The controller 190 controls the first and second lift units 181 and 182.

The first and second lift units 181 and 182 are respectively provided on both ends of each of the first and second scrapers 130 and 140. Each of the first and second lift units 181 and 182 includes a lift motor 181a, 182a which includes a servo motor, a step motor or the like, and a conversion unit 181b, 182b which converts the rotational motion of the lift motor 181a, 182a into vertical linear motion. A variety of linear moving members can be used as the conversion unit 181b, 182b

For example, the linear moving member may include a ball screw which is coupled to the rotating shaft of the lift motor 181a, 182a by a coupling and is rotated by the rotational force of the lift motor 181a, 182a, and an LM guide (linear motion guide) which is threaded over the ball screw and converts the rotational force into linear motion. The first and second lift units 181 and 182 can precisely control the inclination of the corresponding scraper 130, 140.

The first and second lift unit 181 and 182 are installed on a lift member 184 which is supported by a support frame 520 which is provided on the table 510. The lift member 184 is connected to a rapid lift unit 183 so that the first and second lift unit 181 and 182 can be comparatively rapidly moved upwards or downwards by the rapid lift unit 183 with respect to the support frame 520.

The rapid lift unit 183 includes a lift motor 183a which is installed on the support frame 520, and a conversion unit 183b which converts rotational motion of the lift motor 183a into linear motion to move the lift member 184 upwards or downwards.

The conversion unit 183b includes a lead screw (not shown) which is rotated by the drive force of the lift motor 183a, and a ball screw (not shown) which is threaded over the lead screw and coupled to the lift member 184.

The first and second sensors 151 and 152 are respectively provided on sensor support members 153 which are installed on opposite sides of the path along which the light guide plate 111 is transferred. Each of the first and second sensors 151 and 152 includes a light-emitting element which outputs a light beam having a predetermined wavelength downwards, and a light-receiving element which receives the light beam that is outputted from the light-emitting element and then reflected from the light guide plate 111, detects the distance to the light guide plate 111 using the received light beam, and then transmits the detecting signal to the controller 190.

The controller 190 receives the signals from the first and second sensors 151 and 152 and calculates an inclination of the light guide plate 111. Depending on the calculated inclination of the light guide plate 111, the controller 190 controls the first and second lift units 181 and 182 to make the first and second scrapers 130 and 140 level with the light guide plate 111.

In the apparatus 100 for manufacturing the light guide plate according to the embodiment having the above-mentioned construction, when the light guide plate 111 is loaded onto the stage 110, the light guide plate 111 is transferred in the X-axis direction by the light-guide-plate transfer unit 120 while the stage 110 chucks the light guide plate 111 in a vacuum.

During this operation, the first and second sensors 151 and 152 sense how level the light guide plate 111. Depending on how level the light guide plate 111 is, the first and second lift units 181 and 182 adjust the inclinations of the first scraper 130 and the second scraper 140.

After the inclinations of the first scraper 130 and the second scraper 140 have coincided with the inclination of the light guide plate 111, the light guide plate 111 consecutively passes through the first scraper 130 and the second scraper 140.

Then, the teeth 131 and 141 of the first and second scrapers 140 consecutively scrape the upper surface of the light guide plate 111 to form the corresponding portions of the scattering pattern in steps, thus completing the entire scattering pattern.

As such, because the first and second scrapers 130 and 140 are level with the light guide plate 111 before it is scraped, even if the light guide plate 111 is in an inclined state, grooves of the scattering pattern can be formed to a uniform depth in the upper surface of the light guide plate 111.

Furthermore, each of the first and the second scrapers 130 and 140 partially scrapes the light guide plate 111 to form the scattering pattern in steps. Therefore, stress applied to the light guide plate 111 can be dispersed, so that the light guide plate 111 can be prevented from being deformed, and the precision with which the scattering pattern is formed can be increased.

Moreover, the corresponding portions of the scattering pattern are formed in steps in the light guide plate 111 by the first scraper 130 and the second scraper 140. Thus, the teeth 131 and 141 of the first and second scrapers 130 and 140 consecutively come into contact with the light guide plate 111 rather than coming into contact with it at the same time.

Therefore, while the scattering pattern is formed in steps by scraping, the amount of impurities induced by chips or the like can be markedly reduced, thus preventing the formed scattering pattern from being defective.

As described above, standardized unit scrapers each of which includes an individual drive unit to generate drive force in the linear direction can independently move along the surface of a light guide plate. Therefore, even if the light guide plate is curved or twisted, a scattering pattern can be formed on the surface of the light guide plate to a uniform depth.

Furthermore, protrusions which are formed on opposite sides of the scattering pattern while the scattering pattern is formed on the light guide plate by the scraper can be reliably and clearly cut off in a continuous thread shape like a spider's thread without generating very small chips.

In addition, impurities, such as chips, induced when the scattering pattern is formed are reliably removed from the light guide plate during post-processing. Therefore, a defect such as a white point phenomenon can be prevented, and a surface light source having a uniform brightness can be formed.

Moreover, in the present invention, a plurality of scraper assys may be provided. In this case, the scraper assys scrape respective shared portions of the light guide plate to form the entire scattering pattern. Therefore, the light guide plate can be prevented from being thermally deformed by scraping. Furthermore, the lifetime of the teeth of each scraper can be extended.

Although the embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An active scraper, comprising a unit scraper comprising:
a drive-force generating part generating a predetermined intensity of drive force in a linear direction;
a transmitting part to transmit the drive force generated from the drive-force generating part in the linear direction to a body part;
the body part converting the drive force of the transmitting part into a surface-unit drive force corresponding to a width of the body part; and
a scraping part provided on a lower end of the body part, the scraping part receiving the surface-unit drive force and converting the surface-unit drive force into a line-unit drive force, the scraping part having the teeth provided on the scraping part to form grooves of a scattering pattern in a light guide plate at a predetermined pitch.

2. The active scraper as set forth in claim 1, wherein the drive-force generating part comprises:
a drive unit generating the predetermined intensity of the drive force in the linear direction;
a body having a first hole containing the drive unit therein and a second hole communicating with the first hole, the second hole receiving the transmitting part therein; and
a stopper closing an end of the first hole to prevent the drive unit from being removed from the first hole.

3. The active scraper as set forth in claim 2, wherein the drive unit comprises one selected from among a spring, an air cylinder and an oil cylinder.

4. The active scraper as set forth in claim 3, wherein the drive unit generates the predetermined intensity (kgf) of drive force in direct proportion to the number of teeth.

5. The active scraper as set forth in claim 4, wherein the teeth scrape the light guide plate using the drive force to form the grooves of the scattering pattern to a depth ranging from 3 μm to 20 μm.

6. The active scraper as set forth in claim 5, wherein the teeth comprise at least one group of teeth, and the teeth in each group have a same pitch.

7. The active scraper as set forth in claim 1, wherein the teeth of the scraping part are arranged such that the pitch thereof is successively reduced from a first end of the scraping part to a second end thereof.

8. The active scraper as set forth in claim 1, wherein a pitch between each adjacent two of the teeth ranges from 0.2 mm to 2 mm.

9. The active scraper as set forth in claim 8, wherein the opposite ends of the scraping part coincide with bottoms of the corresponding valleys of the teeth, and the teeth comprise a number of teeth satisfying conditions that a sum of widths of the teeth be within a range of 10 mm, and the sum of the widths of the teeth defines a width of a active unit scraper.

10. The active scraper as set forth in claim 8, wherein the active scraper comprises a plurality of unit scrapers arranged in a line to form a scraper assembly.

11. The active scraper as set forth in claim 10, wherein the teeth of the scraper assembly are arranged such that the pitch thereof is successively reduced from one end to the other end of the scraper assembly.

12. The active scraper as set forth in claim 10, wherein the scraper assembly comprises a plurality of groups of unit scrapers;
each group of the unit scrapers has the teeth with a same pitch; and
the groups of unit scrapers are arranged in at least one manner selected from among a first sequence from the group of unit scrapers having a largest pitch to the group of unit scrapers having a smallest pitch, and a second sequence which is a reverse sequence of the first sequence, a third sequence in which values of pitches of the groups alternate, and a combination of at least two of the first, second and third sequences.

13. The active scraper as set forth in claim 11, wherein each of the teeth comprises:
a first scraping portion coming into contact with and scraping the light guide plate to form the scattering pattern; and
a second scraping portion post-processing the scattering pattern formed by the first scraping portion.

14. The active scraper as set forth in claim 13, wherein the first scraping portion has an angle ranging from 75° to 100°, and
the second scraping portion has an angle ranging from 110° to 140°.

15. The active scraper as set forth in claim 10, wherein each of unit scrapers is capable of being moved upwards or downwards according to a shape of a light guide plate when the active scraper is in contact with the light guide plate.

16. An apparatus for manufacturing a light guide plate using a scraper, comprising:
a stage supporting the light guide plate thereon;
a light-guide-plate transfer unit linearly moving the stage in an X-axis direction to transfer the light guide plate linearly; and
a first scraper and a second scraper oriented in a direction perpendicular to the direction in which the light-guide-plate transfer unit linearly moves, the first scraper and the second scraper sharing portions of the light guide plate to be scraped to form a scattering pattern, each of the first and second scrapers coming into contact with the light guide plate and scraping the light guide plate to form grooves of the scattering pattern, each of the first and second scrapers comprising a scraper assembly comprising a plurality of unit scrapers each of which is capable of being moved upwards or downwards using a different intensity (kgf) of drive force,
the scraper assembly having teeth having at least two different pitches.

17. The active scraper as set forth in claim 16, wherein the scraper assembly is configured such that a pitch of the scattering pattern formed on the light guide plate is the greatest at the first end thereof closest to a light source, and such that the pitch of the scattering pattern is successively reduced as a location thereof moves farther away from the light source.

18. The active scraper as set forth in claim 16, wherein the scraper assembly is configured such that a pitch of the scattering pattern formed on the light guide plate is the greatest at the opposite first and second ends thereof closest to respective light sources, and such that the pitch of the scattering pattern is successively reduced from the opposite first and second ends of the light guide plate to a medial portion thereof farthest from the light source.

19. The active scraper as set forth in claim 16, wherein each of the unit scrapers generates a predetermined intensity (kgf) of drive force in direct proportion to the number of teeth.

20. The active scraper as set forth in claim 17, wherein the scraper assembly comprises a plurality of groups of unit scrapers;
each group of the unit scrapers has the teeth with the same pitch; and
the pitches of the groups of the unit scrapers are varied according to a distance from their nearest light source in a way that as the distance from the nearest light source is increased, the pitch of the group is the reduced.
